(19) United States
(12) Patent Application Publication
(10) Pub. No.: US 2001/0005497 A1
(43) Pub. Date: Jun. 28, 2001

(54) Process for treating sodium aluminosilicate

(76) Inventors: Yasuo Kawai, Kanagawa (JP); Isao Ishikawa, Kanagawa (JP); Yoshiyuki Takenaka, Tokyo (JP); Hideya Saito, Tokyo (JP); Mineo Nozaki, Tokyo (JP)

Correspondence Address: SUGHRUE, MION, ZINN,, MACPEAK & SEAS, PLLC, 2100 Pennsylvania Avenue, N.W., Washington, DC, 20037-3213, US

(21) Appl. No.: 09/749,653

(22) Filed: Dec. 28, 2000

Related U.S. Application Data
(60) Provisional application No. 60/189,491, filed on Mar. 15, 2000.

(30) Foreign Application Priority Data
Dec. 28, 1999 (JP) HEI. 11-375467

(51) Int. Cl. C01D 1/00; C01B 33/26

(52) U.S. Cl. 423/179; 423/328.1

(57) ABSTRACT

The present invention provides a process for treating sodium aluminosilicate which includes adding a calcium compound to sodium aluminosilicate; thermally treating the mixture of the sodium aluminosilicate and the calcium compound; and eluting the thermally-treated product with water or an aqueous solution to thereby solubilize a sodium component of the sodium aluminosilicate, recover sodium, and obtain a useful product containing sodium in very small amounts. The elution percentage of sodium can be increased by optimizing heating and elution conditions.

### CROSS REFERENCE TO RELATED APPLICATIONS

This application is an application filed under 35 U.S.C. §111(a) claiming benefit pursuant to 35 U.S.C. §119(e)(1) of the filing date of Provisional Application 60/189,491 filed Mar. 15, 2000 pursuant to 35 U.S.C. §111(b).

### FIELD OF THE INVENTION

The present invention relates to a process for treating sodium aluminosilicate.

The present invention enables separation of sodium from sodium aluminosilicate, which is usually disposed of or not used effectively. Examples of such aluminosilicate include red mud and sodalite, which is produced during production of alumina or aluminum; zeolites, which are employed in a variety of uses; and naturally occurring zeolites and sodalite. In the present invention, sodium can be recovered and recycled, and a residue which does not contain sodium can be effectively used as a raw material for cement.

### BACKGROUND OF THE INVENTION

A typical component containing sodium aluminosilicate is red mud, which is a by-product of aluminum hydroxide or alumina production. Approximately 800 kg of red mud is produced for every 1 ton of alumina. Red mud predominantly comprises sodium aluminosilicate, which contains Al₂O₃, SiO₂, and Na₂O; and Fe₂O₃. Red mud also comprises other components in an amount of a few percent, such as TiO₂, quartz, alumina hydrate, and a lime compound. Red mud may be used as a raw material for producing cement or iron. However, red mud contains excessive Na to be used as a raw material for cement, and excessive Al to be used as a raw material for iron. Therefore, red mud is considered difficult to use, and has hitherto been disposed of as industrial waste without putting to effective use.

Japanese Patent Application Laid-Open (kokai) No. 50-16608 discloses a process for recovering useful components (Fe, Na, and Al) from red mud. In the process, a CaO-containing component is added to red mud at a predetermined ratio. The resultant mixture is melted through reducing thermal treatment, and the molten mixture is separated into iron and slag, and Na and Al components are recovered from the slag through alkali elution. However, in the process, only 60-70% of the Na present in the red mud is actually recovered, leaving a considerable amount of Na in the residue. Thus, the residue cannot be effectively used as, for example, a raw material for cement. In the process, red mud containing approximately 40% iron is thermally treated, and therefore a large quantity of heat is required.

Other examples of sodium aluminosilicate include zeolites, which are employed in a variety of uses. Zeolites are generally used as a carrier which supports a metal catalyst or a noble metal. Alternatively, zeolites are used for carrying out ion exchange. Some zeolites are subjected to regeneration treatment and reused, but in most cases, zeolites serving as carriers are disposed of as industrial waste after removal of toxic or useful components.

As described above, various methods for effectively using some sodium aluminosilicate have been proposed, but actually, residue after removal of useful components or sodium aluminosilicate per se is not put to effective use and is disposed of.

In view of the foregoing, an object of the present invention is to provide a process for treating sodium aluminosilicate, in which a useful Na component is recovered from components of sodium aluminosilicate, and a substance which is disposed of as a residue can be effectively used as a raw material for cement due to very low Na content.

### SUMMARY OF THE INVENTION

In order to effectively use sodium aluminosilicate which is disposed of without effectively or never being used, the present invention provides a process for treating sodium aluminosilicate, in which an Na component is recovered at a high rate from a variety of sodium aluminosilicates and a useful substance containing a very small amount of Na is obtained. The process comprises

(1) A calcium compound is added to sodium aluminosilicate and they are mixed. Examples of calcium compounds include a single calcium compound such as calcium oxide, calcium carbonate, calcium hydroxide, or calcium sulfate; a mixture thereof; and another mixture containing these calcium compounds. Of these compounds, calcium oxide is preferably added to sodium aluminosilicate. When a calcium component of a calcium compound which is added to a sodium aluminosilicate is represented by “CaO,” and a sodium component and a silicon component of the sodium aluminosilicate are represented by “Na₂O” and “SiO₂,” respectively, the ratio by mol of CaO to Na₂O (CaO/Na₂O) or (preferably “and”) the ratio by mol of CaO to SiO₂ (CaO/SiO₂) is about 1-5, preferably about 2-4. No particular limitation is imposed on the particle sizes of sodium aluminosilicate and a calcium compound which is added, but they have a particle size of about 1-300 μm, preferably about 60 μm or less. The mixture of sodium aluminosilicate and a calcium compound may be in a dried state or a wet state, but preferably in a wet state.

(2) The mixture obtained in (1) is subjected to thermal treatment by use of a heating unit such as a kiln at about 800-1,400° C., preferably about 1,000-1,350° C. No particular limitation is imposed on the form of the mixture that is thermally treated, and the mixture may assume a powder form or a pellet form. The time for thermal treatment is about 5-180 minutes, preferably about 20-80 minutes.

(3) Exhaust gas of high temperature which is generated in the heating unit is employed for producing steam in a boiler, and energy is recovered from waste heat.

(4) The thermally-treated product obtained in (2) is subjected to elution treatment with water (or an aqueous solution), to thereby elute and recover sodium. When elution treatment is carried out, the amount of water (or an aqueous solution) which is employed is about 1-30 times the weight of the thermally-treated product, preferably about 10-20 times the weight. The elution temperature is about 50° C. or higher, preferably about 70° C. or higher. The elution time is about 10-120 minutes, preferably about 60-90 minutes.

(5) The slurry obtained in (4) is separated into solid and liquid by use of a filtering unit. The resultant cake is further washed with water. The above-filtrate and the solution which is obtained through washing of the cake is effectively used, as a sodium-containing solution, in a process in which an alkali solution must be used. The cake (hereinafter a residue after elution of sodium may be referred to as “residue after sodium recovery”) is recycled as a raw material for cement. The solution which is obtained through washing of the cake may be employed in the elution treatment of the thermally-treated product obtained in (2).

### BRIEF DESCRIPTION OF THE DRAWINGS

FIG. 1 shows an embodiment of the process of the present invention.

FIG. 2 is a diagram showing an example of the configuration of units for carrying out the process of the present invention (Part 1).

FIG. 3 is a diagram showing an example of the configuration of units for carrying out the process of the present invention (Part 2).

FIG. 4 is a diagram showing an example of the configuration of units for carrying out the process of the present invention (Part 3).

### DESCRIPTION OF THE PREFERRED EMBODIMENTS

In the present invention, sodium aluminosilicate may be sodalite, which is discharged during production of aluminum hydroxide, alumina, and metallic aluminum; zeolites, which have been employed in a variety of uses; or naturally-occurring or synthesized zeolites or sodalite.

Sodalite which is discharged during production of aluminum generally contains Na₂O, Al₂O₃, SiO₂, and impurities such as Fe₂O₃ in amounts of about 18-25 wt. %, about 31-38 wt. %, about 28-35 wt. %, and about 5 wt. % or less, respectively. Typical examples of zeolites are represented by the following chemical formulas: CaO.Al₂O₃.4SiO₂.6.5H₂O, Na₂O.Al₂O₃.2SiO₂.4.5H₂O, and Na₂O.Al₂O₃.2.5SiO₂.6H₂O.

Sodium aluminosilicate may be obtained through bauxite treatment, as red mud containing an iron component. In the present invention, sodium aluminosilicate which is separated from an iron component is preferably used. Sodium aluminosilicate which is preferably used in the present invention contains a sodium aluminosilicate component in an amount of about 90 wt. % or more, preferably about 95 wt. % or more, and an iron component as reduced to Fe₂O₃ in an amount of about 10 wt. % or less, preferably about 5 wt. % or less. In bauxite treatment, there is known a method for obtaining sodium aluminosilicate which is separated from an iron component. Even when sodium aluminosilicate containing an iron component and other metallic components is used, the sodium aluminosilicate does not raise any problems. However, when sodium aluminosilicate containing a sodalite component in large amounts is used, the energy which is consumed for per unit weight of sodium aluminosilicate can be reduced.

Examples of calcium compounds which may be used include calcium oxide, calcium carbonate, calcium hydroxide, calcium sulfate, and a mixture thereof. Of these, calcium oxide is preferably used. When a calcium compound is mixed with sodium aluminosilicate and the mixture is thermally treated, the reaction between the calcium compound and the sodium aluminosilicate proceeds, converting a sodium component into a compound which can be eluted with water. The resultant elutable product may be a product containing sodium aluminate.

When a calcium component of a calcium compound which is added to sodium aluminosilicate is represented by “CaO,” and a sodium component and a silicon component of the sodium aluminosilicate are represented by “Na₂O” and “SiO₂,” respectively, the ratio by mol of CaO to Na₂O (CaO/Na₂O) and/or the ratio by mol of CaO to SiO₂ (CaO/SiO₂) are generally about 1 or more, preferably about 1-5, more preferably about 2-4. When the ratio is less than 1, a sodium component of sodium aluminosilicate cannot be sufficiently converted into an elutable compound. In contrast, when the ratio is very high, a compound which is difficult to elute is produced, and thus the elution percentage of a sodium component may be reduced.

When sodium aluminosilicate is mixed with a calcium compound, these compounds are preferably crushed so as to make them into particles of small sizes. No particular limitation is imposed on the particle size, but each compound preferably contains particles having a particle size of about 1-300 μm, more preferably about 80 μm or less, much more preferably about 60 μm or less. When the particle has a smaller size, the elution percentage of sodium can be increased. However, not all particles are required to have a particle size falling within the above range. When particles having a particle size falling within the above range account for at least about 60 wt. %, preferably at least about 80 wt. %, the elution percentage can be increased. It has been elucidated that regulation of particle size is effective for increasing the elution percentage of sodium and obtaining a residue containing a sodium component in an amount of about 1% or less. However, the particles do not need to be made very small, in view of cost.

Sodium aluminosilicate may be mixed with a calcium compound in a dried state. However, they are preferably mixed in a wet state by adding water, since a portion of CaO is dissolved in a liquid phase in the form of Ca(OH)₂ and substitution-reaction of Na of sodalite with Ca occurs in a liquid phase before thermal treatment. When sodium aluminosilicate is mixed with a calcium compound in a wet state, the mixture can be pelletized, which is preferable. When the mixture is pelletized, generation of dust is prevented during thermal treatment, and pellets are transferred with ease. Even when mixed particles are pelletized, the reactivity of the pellet depends on the particle size before pelletization, and thus the particles preferably have a particle size falling within the above-described range.

A mixture of sodium aluminosilicate and a calcium compound is heated generally at about 800-1,400° C., preferably at about 1,000-1,350° C. The heating temperature greatly affects the elution percentage of a sodium component after heating. Therefore, in order to produce a compound which is easy to elute, the heating temperature must be set within a certain range. The mixture may be heated in the atmosphere. No particular limitation is imposed on the heating time, but the time is generally about 5-180 minutes, preferably about 20-80 minutes. No particular limitation is imposed on the rate of temperature increase, but the rate is generally about 10-30° C./minute. The heated product may be rapidly or gradually cooled. No particular limitation is imposed on the type of heating unit, but industrially, a kiln is advantageous (hereinafter a substance which is produced through the aforementioned thermal treatment may be referred to as a “thermally-treated product”).

After completion of thermal treatment, the thermally-treated product is preferably crushed for carrying out elution with ease.

Elution is carried out with water or an aqueous solution. No particular limitation is imposed on the amount of water or aqueous solution, but the amount is preferably about 1-30 times the weight of the thermally-treated product, more preferably about 10-20 times the weight. When hot water is used, elution can be accelerated. Hot water which is used generally has a temperature of about 50°C. or higher, preferably about 70° C. or higher. No particular limitation is imposed on the elution time, but the time is about 5-120 minutes, preferably about 60-90 minutes.

As described above, in the present invention, sodium aluminosilicate is mixed with a calcium compound, the resultant mixture is thermally treated, and a sodium component is eluted. As a result, the amount of sodium component of a residue after elution can be considerably reduced. When the above-described conditions are appropriately chosen, the amount of sodium in a residue can be reduced to about 1% or less, about 0.6% or less, about 0.1% or less, and particularly about 0.01% or less. As a result, a residual solid product after recovery of sodium, which predominantly contains calcium silicate, can be used as a raw material for cement. In addition, when the amount of sodium recovered from sodium aluminosilicate is calculated as a recovery percentage of sodium, in the present invention, the recovery (extraction) percentage can attain about 95% or more, further about 99% or more, and particularly about 99.9% or more. Conventionally, such a high recovery (extraction) percentage of sodium is not known to be attainable. However, in the present invention, the amount of sodium in a residual solid product after recovery of sodium can be reduced to about 1% or less, and thus the solid product can be used as a raw material for cement. This fact enhances the utility of the present invention.

In the case in which the thermally-treated product is subjected to elution treatment with water or an aqueous solution, when an alumina component is eluted together with a sodium component, the resultant elution solution per se can be recycled in bauxite treatment (e.g., Bayer's process). As a result, separating the sodium and alumina components becomes unnecessary. On the other hand, even when an alumina component remains in a residue after elution, the residue can be used as a raw material for cement and raises no problem. When a residue after elution contains no alumina component, the residue is preferably used as a raw material for cement.

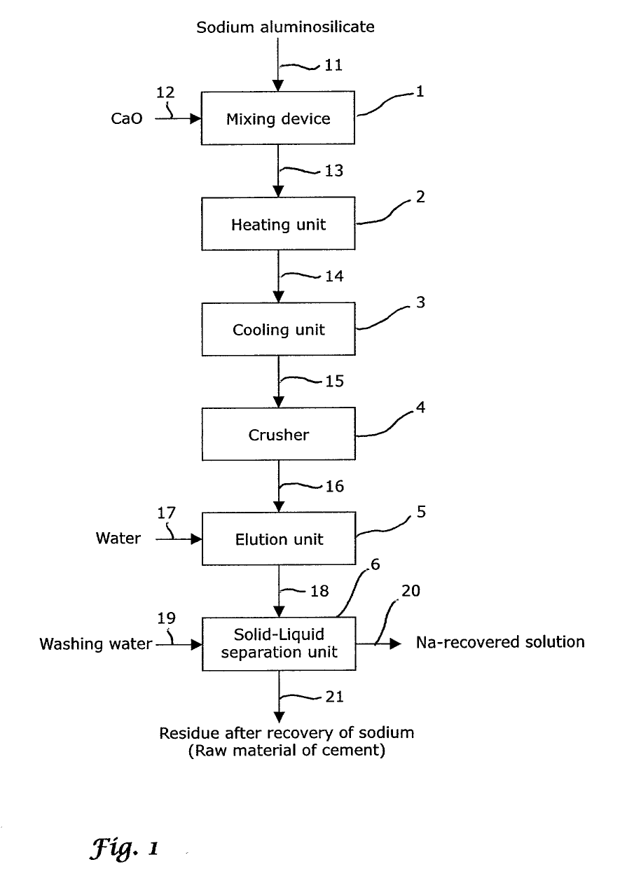

An embodiment of the process of the present invention will be described in reference to FIG. 1. The treatment process mainly comprises thermal treatment and elution.

### Thermal Treatment Process

Various sodium aluminosilicates and CaO serving as an additive are supplied to a mixing device 1, such as a kneader or a kneading machine, through a line 11 and a line 12, respectively. The aluminosilicates and CaO are mixed well in the mixing device. The resultant mixture is supplied to a heating unit 2, such as a kiln, through a line 13, and thermally treated at about 1,000-1,350° C. The thermally-treated product is fed to a cooling unit 3, such as a rotary cooler or a steel belt cooler, through a line 14 and cooled. Thereafter, the resultant product is supplied to a crusher 4 such as a hammer mill through a line 15, and crushed therein.

### Elution Process

The product which is crushed in the crusher 4 in the thermal treatment process is supplied to an elution unit 5 through a line 16. Water (or an aqueous solution) is also supplied to the elution unit 5 through a line 17. The mixture is stirred in the unit and subjected to elution treatment at about 50-100° C. The resultant slurry in the elution unit 5 is discharged through a line 18, and the slurry is separated into solid and liquid in a solid-liquid separation unit 6, such as a horizontal belt filter or a rotary drum filter. The thus-obtained filtrate containing sodium serving as a useful component is discharged through a line 20 and recycled. The thus-separated cake is washed with washing water, and discharged through a line 21. The resultant residue after recovery of sodium predominantly contains calcium and silica, and contains sodium in an amount of about 1% or less, and thus the residue can be effectively used as a raw material for cement. The washing water which is used for washing the cake is removed through the line 20 and recycled.

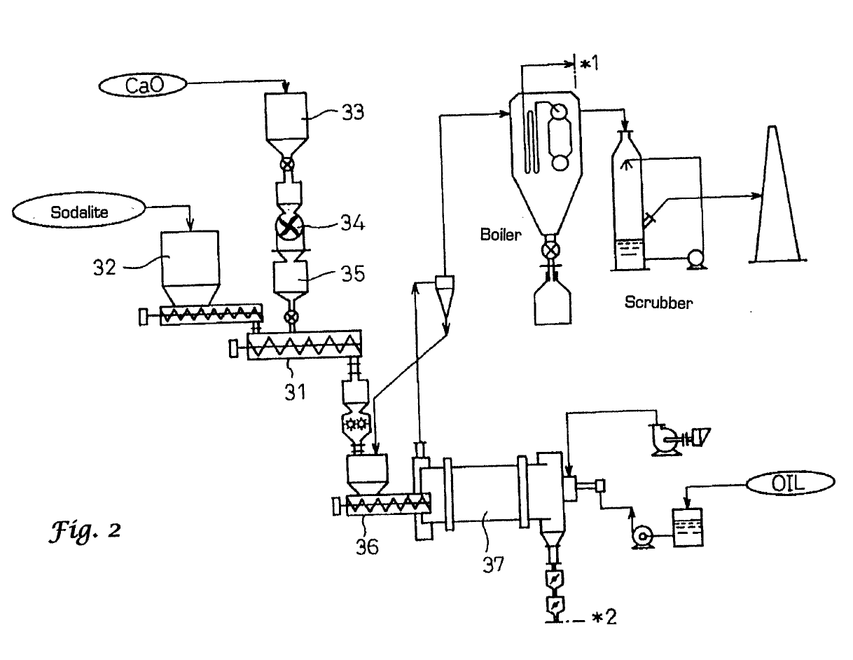

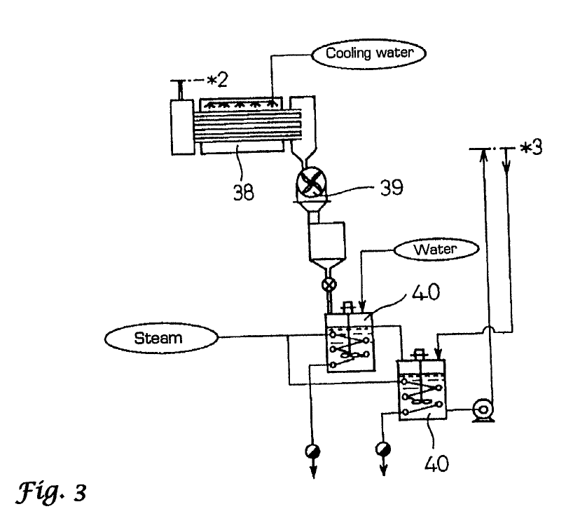

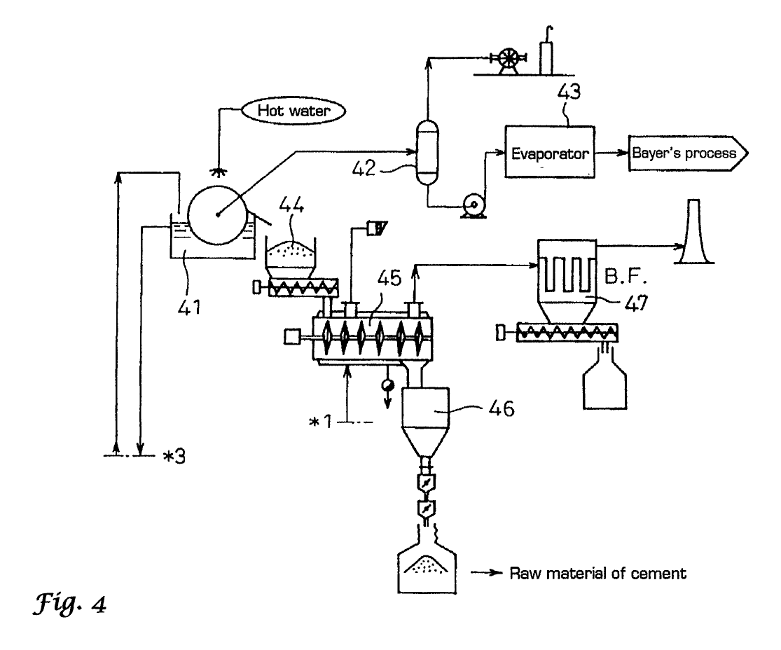

FIGS. 2 to 4 show specific examples of the structure of apparatuses for carrying out the process of the present invention. The process is illustrated by means of these three figures. As shown in these figures, a predetermined amount of sodalite having a predetermined particle size is supplied to a mixing device 31 through a sodalite hopper 32. Also, a predetermined amount of CaO having a predetermined particle size is supplied to the mixing device 31 through a CaO hopper 33, a CaO crusher 34, and a CaO feeder 35 which constantly supplies CaO. These compounds are mixed in the mixing device 31, and the mixture is fed to a kiln 37 through a feeder 36 and thermally treated at a predetermined temperature. The thermally treated product is cooled in a cooling unit 38, and then crushed in a crusher 39. Subsequently, the crushed product is subjected to elution treatment in an elution container 40 by use of hot water. After elution, the resultant slurry is separated into filtrate and cake in a filtering unit 41. After being treated in a filtrate separator 42 and an evaporator 43, the filtrate is used in an alumina production process, such as Bayer's process. The cake is fed to a drying unit 45 through a cake-receiving container 44, and discharged into a dried cake receiver 46. The dried cake is used as a raw material for cement. Reference numeral 47 represents a bag filter.

### EXAMPLES

Unless otherwise indicated herein, all parts, percents, ratios and the like are by weight.

### Test Example 1

Table 1 shows analytical values of sodalite obtained in a desilication process which is added to Bayer's process for producing aluminum hydroxide alumina. The sodalite, CaO having a particle size of 53 μm or less, and water were fed into a mixing device. The amount of water was 40% on the basis of the entirety of the mixture. In this case, when a silicon component of the sodalite was represented by “SiO₂,” the ratio by mol of CaO to SiO₂; i.e., CaO/SiO₂, was 3. The mixture was thermally treated in a kiln at 1,200° C. for a residence time of 30 minutes. Subsequently, the thermally treated product was fed to a cooling unit. After being cooled, the product was crushed by use of a crusher.

The thus-crushed product was fed to an elution tank, and water was added in an amount of 20 times the weight of the thermally treated product (the crushed product). The mixture was stirred well at 90° C. for 60 minutes, and the mixture was subjected to elution treatment. Thereafter, the obtained slurry was fed to a filtering unit, and the slurry was separated into solid and liquid. The separated cake was washed well with water.

The thus-recovered solution and the cake were chemically analyzed for the Na content to calculate the recovery percentage of sodium and the concentration of sodium remaining in the cake. As a result, the recovery percentage of sodium was found to be as high as 99.9%, and the concentration of sodium remaining in the insoluble residue was as low as 0.01% (dry). Therefore, a useful product which can be used as a raw material for cement was obtained.

TABLE 1
Analytical Values Of Sodalite

| Item | SiO₂ (wt %) | Al₂O₃ (wt %) | Na₂O (wt %) | Ig-loss |
|---|---|---|---|---|
| Analytical value | 33.8 | 34.9 | 23.0 | 8.3 |

### Test Example 2

The same sodalite as used in Test Example 1 and CaO having a particle size of in excess of 300 μm were fed into a mixing device, and these compounds were mixed. In the same procedure as in Test Example 1, the ratio by mol of CaO to SiO₂; i.e., CaO/SiO₂, was 3. The resultant mixture was thermally treated in a kiln at 1,200° C. for 60 minutes. Subsequently, the thermally treated product was fed to a cooling unit. After being cooled, the product was crushed by use of a crusher.

The thus-crushed product was fed to an elution tank, and water in an amount of 20 times the weight of the thermally treated product (the crushed product) was added to the crushed product. The mixture was stirred well at 90° C. for 60 minutes, and then subjected to elution treatment. Thereafter, the thus-obtained slurry was fed to a filtering unit, and the slurry was separated into solid and liquid. The separated cake was washed well with water.

The thus-recovered solution and the cake were chemically analyzed for the Na content to calculate the recovery percentage of sodium and the concentration of sodium remaining in the cake. As a result, the recovery percentage of sodium was found to be 22.5%, and the concentration of sodium remaining in the insoluble residue was found to be 8.81% (dry).

### Test Example 3

The same sodalite as used in Test Example 1 and CaO having a particle size of 53 μm or less were fed into a mixing device, and these compounds were mixed. In the same manner as in Test Example 1, the ratio by mol of CaO to SiO₂; i.e., CaO/SiO₂, was 3. The resultant mixture was thermally treated in a kiln at 800° C. for a residence time of 30 minutes. Subsequently, the thermally treated product was fed to a cooling unit. After being cooled, the product was crushed by use of a crusher.

The thus-crushed product was fed to an elution tank, and water in an amount of 20 times the weight of the thermally treated product (the crushed product) was added to the crushed product. The mixture was stirred well at 90° C. for 60 minutes, and the mixture was subjected to elution treatment. Thereafter, the thus-obtained slurry was fed to a filtering unit, and the slurry was separated into solid and liquid. The separated cake was washed well with water.

The thus-recovered solution and the cake were chemically analyzed for the Na content to calculate the recovery percentage of sodium and the concentration of sodium remaining in the cake. As a result, the recovery percentage of sodium was found to be 61.8%, and the concentration of sodium remaining in the insoluble residue was found to be 4.33% (dry).

### Test Example 4

Testing was carried out by use of synthetic zeolite 4A which had been used previously. Table 2 shows analytical values of the synthetic zeolite 4A. The zeolite and CaO were fed into a mixing device, and these compounds were mixed. In this case, when a silicon component of zeolite was represented by “SiO₂,” the ratio by mol of CaO to SiO₂; i.e., CaO/SiO₂, was 3. The mixture was thermally treated in a kiln at 1,200° C. for 60 minutes. Subsequently, the thermally treated product was fed to a cooling unit. After being cooled, the product was crushed by use of a crusher.

The thus-crushed product was fed to an elution tank, and water in an amount of 20 times the weight of the thermally treated product (the crushed product) was added to the crushed product. The mixture was stirred well at 90° C. for 60 minutes, and the mixture was subjected to elution treatment. Thereafter, the thus-obtained slurry was fed to a filtering unit, and the slurry was separated into solid and liquid. The separated cake was washed well with water. The thus-recovered solution and the cake were chemically analyzed for the Na content to calculate the recovery percentage of sodium and the concentration of sodium remaining in the cake. As a result, the recovery percentage of sodium was found to be as high as 93.4%, and the concentration of sodium remaining in the insoluble residue was found to be as low as 0.66% (dry). Therefore, a useful product which can be used as a raw material for cement was obtained.

TABLE 2
Analytical Values Of Zeolite (used synthetic zeolite 4A)

| Item | SiO₂ (wt. %) | Al₂O₃ (wt. %) | Na₂O (wt. %) | Ig-loss |
|---|---|---|---|---|
| Analytical value | 36.7 | 30.7 | 17.7 | 21.0 |

As described above, the present invention exhibits the following effects.

(1) Sodium serving as a useful component can be recovered almost completely from sodium aluminosilicate contained in waste or unused natural resource.

(2) A raw material for cement containing sodium in very low amounts can be produced from sodium aluminosilicate contained in waste or unused natural resource.

While the invention has been described in detail and with reference to specific embodiments thereof, it will be apparent to one skilled in the art that various changes and modifications can be made therein without departing from the spirit and scope thereof.

What is claimed is:

1. A process for treating sodium aluminosilicate which comprises adding a calcium compound to sodium aluminosilicate to form a mixture, heating the resultant mixture of the sodium aluminosilicate and a calcium compound, subjecting the heated mixture to an elution treatment in the presence of water or an aqueous solution thereby solubilizing a sodium content of the sodium aluminosilicate for recovery of sodium, and obtaining a useful substance having a very small Na content.

2. A process for treating sodium aluminosilicate according to claim 1, wherein the calcium compound is (1) a single calcium compound selected from the group consisting of calcium oxide, calcium carbonate, calcium hydroxide, and calcium sulfate; or (2) a mixture of two or more of the single calcium compounds.

3. A process for treating sodium aluminosilicate according to claim 1 or 2, wherein, when a sodium component and a silicon component of the sodium aluminosilicate are represented by “Na₂O” and “SiO₂,” a calcium component of the calcium compound is represented by “CaO,” and a ratio by mol of CaO to Na₂O (CaO/Na₂O) or a ratio by mol of CaO to SiO₂ (CaO/SiO₂) is about 1-5.

4. A process for treating sodium aluminosilicate according to claim 1 or 2, wherein the sodium aluminosilicate and the calcium compound individually comprise at least about 60 wt. % of particles having a particle size of about 300 μm or less.

5. A process for treating sodium aluminosilicate according to claim 1 or 2, further comprising mixing the sodium aluminosilicate and the calcium compound in a state in which the resultant mixture is wet.

6. A process for treating sodium aluminosilicate according to claim 1 or 2, wherein heating is a thermal treatment carried out at a temperature of about 1,000-1,350° C. for about 5-180 minutes.

7. A process for treating sodium aluminosilicate according to claim 1 or 2, further comprising pulverizing or crushing a thermally-treated product of the sodium aluminosilicate and the calcium compound during elution of sodium to obtain a pulverized material or crushed material, wherein the amount of water or the aqueous solution added to the pulverized material or crushed material is 1-30 times the weight of the thermally-treated product, and the elution treatment is carried out at a temperature of about 50° C. or higher for about 5-120 minutes.

8. A process for treating sodium aluminosilicate according to claim 7, further comprising separating a slurry obtained from the elution treatment into solid and liquid, thoroughly washing the resultant cake with water, and obtaining a sodium recovery residue having a sodium content of about 1% or less.

9. A process for treating sodium aluminosilicate according to claim 1 or 2, further comprising removing an entirety of or a portion of sodium from a thermally-treated substance of the sodium aluminosilicate and the calcium compound to obtain a sodium recovery residue having a sodium content of about 1% or less, and using the sodium recovery residue as a raw material for cement.

10. A process for treating sodium aluminosilicate according to claim 1 or 2, wherein the process comprises recycling the aqueous solution from which sodium has been recovered in a facility that requires an alkali solution or sodium hydroxide.

11. A process for treating sodium aluminosilicate according to claim 10, wherein facility that requires an alkali solution or sodium hydroxide is a Bayer's process.
